(19) United States
(12) Patent Application Publication
(10) Pub. No.: US 2006/0055184 A1
(43) Pub. Date: Mar. 16, 2006

(54) Side door of a motor vehicle

(76) Inventor: Michael Fuetterer, Hildrizhausen (DE)

Correspondence Address: CROWELL & MORING LLP;INTELLECTUAL PROPERTY GROUP, P.O. BOX 14300, WASHINGTON, DC, 20044-4300, US

(21) Appl. No.: 11/209,718

(22) Filed: Aug. 24, 2005

(30) Foreign Application Priority Data
Aug. 28, 2004 (DE) 10 2004 041 742.3

(51) Int. Cl. E05B 3/00

(52) U.S. Cl. 292/336.3

(57) ABSTRACT

A side door of a motor vehicle has a side window pane which is enclosed by a door frame. A locking device is arranged in the region of the side pane and/or the door frame. The side door can be locked in relation to a roof frame or a motor vehicle column above a flange edge by the locking device.

This application claims the priority of German application 10 2004 041 742.3, filed Aug. 28, 2004, the disclosure of which is expressly incorporated by reference herein.

### BACKGROUND AND SUMMARY OF THE INVENTION

The present invention concerns a side door of a motor vehicle including a side pane that is enclosed by a door frame.

Side doors of motor vehicles are as a rule fastened by hinges on an A column or a B column, and locking devices are provided on opposite sides of the side doors. Such a locking device, located on the B column or on a C column, is arranged underneath the flange edge of the motor vehicle. The side door has a door frame in which a side pane is enclosed.

Such side door is, for example, disclosed in German document DE 41 06 715 C2. Wind noises can occur in the region of the door frame, especially with very long side doors. For this reason, the side door is prestressed along its vertical extension by a slight curvature in relation to a motor vehicle body, owing to which the entire door is pressed against the automobile body. The wind noise is indeed reduced in this way, but an unpleasant springing action of the door and a higher expenditure of force when activating the door lock are observable for the user due to the prestressing.

One object of this invention is to provide a side door for a motor vehicle which has a minimized prestressing in relation to the side wall of the motor vehicle in comparison with the state of the art.

According to the invention, this object is achieved by way of a side door for a motor vehicle with a locking device which is arranged in a region of at least one of the side pane and the door frame and with which the side door can be locked in relation to a roof frame or a motor vehicle column above a flange edge.

According to the invention, in a side door of a motor vehicle with a side pane which is frequently configured collapsible into a door body and which is enclosed by a door frame, a locking device is arranged in the region of the side pane and/or the door frame. In this way, the side door is lockable in relation to a roof frame or in relation to the motor vehicle column above a flange edge.

The side door is locked fast with the automobile body above the flange edge, especially in the region of the roof frame, by the locking of the side door in accordance with the invention. In this way, the degree of prestressing of the side door in relation to the motor vehicle frame can be diminished or wholly omitted.

To prestress the side door, the latter is provided with a slightly high curvature along its Vertical course in relation to the motor vehicle body. When closing the side door, this curvature in relation to the motor vehicle body, to which the side door is adapted, is compensated for analogously to a spring element by an increased contact pressure of the side door, especially in the region of the roof frame. Through this increased contact pressure, the tendency toward wind noises in the door region is diminished.

The same effect, namely diminishing wind noise in the door region, is nonetheless also attained by locking the side door in accordance with the invention. Prestressing of the side door can consequently be diminished, which means an improvement of the feeling of opening the door for the user.

At the same time, bending the door frame out by an unauthorized user is made difficult by the locking above the flange edge, which consequently provides an improved protection against theft.

The locking device includes a locking pin which is arranged moveably along a guide in one embodiment of the invention. Locking in this construction can be realized in a technically particularly beneficial manner.

Here the locking device is arranged on a door frame component which basically runs parallel to a middle column. In this way, the locking device can be arranged on the door in a particularly space-saving manner.

The locking pin advantageously stands in engagement with a receiving opening in the roof frame.

The locking device can be arranged in a space-saving manner especially beneficially in a hollow space of the door frame.

The locking device can also be arranged directly on a side pane, and a passage opening through the door frame into the roof frame or a passage opening through the door frame into the motor vehicle column may be provided. The locking pin consequently runs through these passage openings and stands in engagement with either the roof frame or the motor vehicle column.

The locking device can be glued on its place of destination in an advantageous configuration. Various materials can be combined with one another sufficiently fast by a cement connection. Consequently the material of the locking device can largely be freely selected.

Here, for example, the use of a light metal section or a plastic section is appropriate for the guide of the locking device. At the same time, the locking pin can be made of various materials such as, for example, steel, plastic or a fiber-reinforced plastic. A combination of various materials, such as, for example, steel in an upper region and fiber-reinforced plastic in a lower region of the locking pin, is likewise appropriate.

Advantageous refinements of the invention are explained with reference to the drawing figures.

### BRIEF DESCRIPTION OF THE DRAWINGS

FIG. 1 is a schematic representation of a motor vehicle side wall with two side doors,

FIG. 2 is a view along section line II-II of FIG. 1 showing a locking device in longitudinal section,

FIG. 3 is a view along section line III-III of FIG. 1 showing a cross section through the locking device, and

FIG. 4 is a view along section line IV-IV of FIG. 1 which illustrates a cross section through a further variant of the locking device.

### DETAILED DESCRIPTION OF THE INVENTION

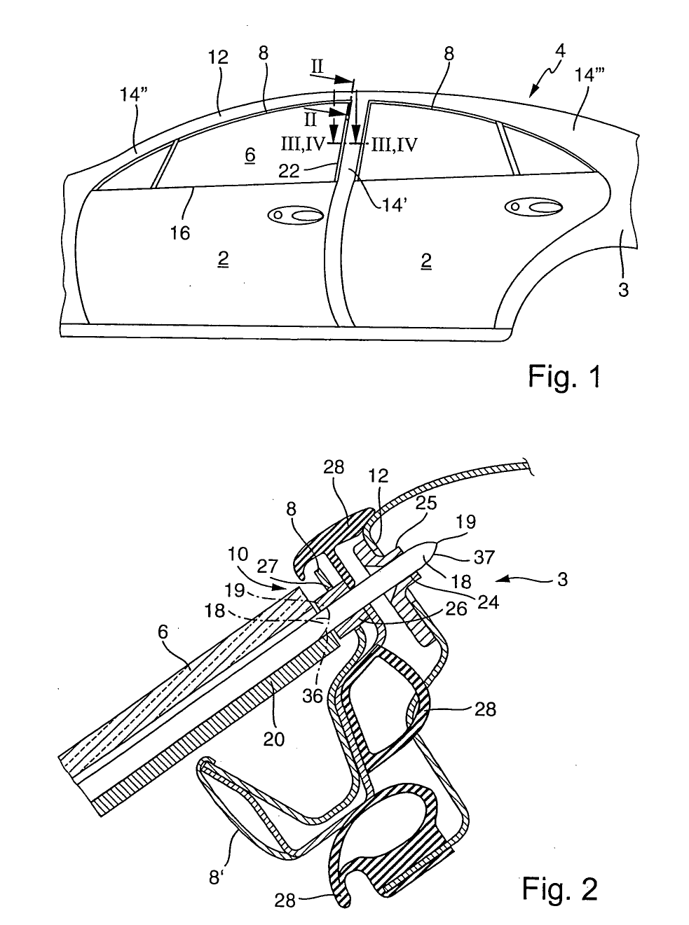

A schematic representation of a motor vehicle side wall of a motor vehicle 4 is presented in FIG. 1. The motor vehicle has two side doors 2. Each side door includes a side pane (window pane) 6 which is enclosed by a door frame 8. The side wall 3 of the motor vehicle 4 includes three motor vehicle columns 14 (14′, 14″, 14′″), as well as a roof frame 12.

The side doors are pivoted with hinges not represented here on the motor vehicle columns (14′, 14″, 14′″) beneath the edge rim 16 and likewise latched with a closing device beneath the edge rim 16.

A longitudinal section through a locking device of the invention is represented in FIG. 2, whereby the section runs along line II-II in FIG. 1. The cutout shows the transition region of the side door 2 with the door frame 8 which lies on the roof frame 12 of side wall 3. Here the side pane 6 is enclosed by the door frame 8. The door frame 8 extends to an interior side of the side pane and there forms the interior frame 8′. The door interior frame 8′ lies on door seals 28 which are once again fastened on the door frame 12. The side pane 6 is represented in FIG. 2 in the closed state.

A locking device 10 is provided; in this example, the locking device is fastened directly on the window pane 6 by a cement connection such as, for example, a gluing seam 34. The locking device 10 has a guide 20 which is configured in the shape of an aluminum extrusion section in which a locking pin 18 is arranged.

The locking pin 18 has a tip 19. The locking pin 18 is represented in two end positions in FIG. 2, whereby position 36 (indicated by the tip 19, finally with an upper edge of the guide 20) is an unlocked position. Position 37 (tip 19 in the roof frame 12) is a locked position of the locking pin 18.

Here the locking pin 18 is slid along the guide 20. The locking pin 18 thereby penetrates a passage opening 27 in door frame 8 (here a vertically running door frame component which lies on the roof frame 12). Furthermore, the locking pin 18 is moved into a receiving opening 24 of the roof frame 12. Here it lies on an adjustable receiving plate 25 which is fastened in the receiving opening 24. Preferably the receiving plate is screwed with the roof frame 12. In this position (position 37), the side door 2 is locked in relation to the roof frame 12 by the locking device 10.

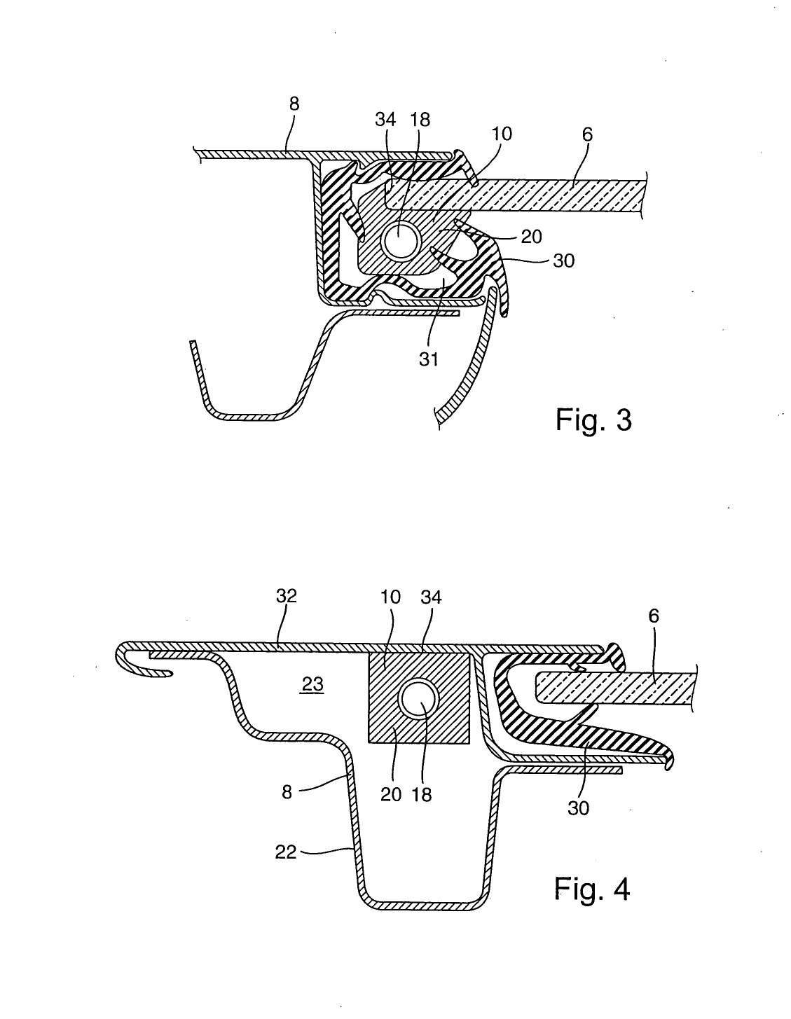

FIG. 3 depicts a cross section through the locking device according to FIG. 2. Here it should be recognized that the guide 20 is fastened with the locking pin 18 on the side pane 6 by the gluing seam 34. The guide rail 20 is consequently arranged vertically along the side pane 6 and is enclosed by the door frame 8 which hereby has a U-shaped cross section region for enclosing the side pane 6. Here once again a pane sealing is arranged in the U-shaped cross section region of the door frame 8, whereby the pane sealing 30 seals off the locking device 10 as well as the side pane 6.

A further possible arrangement of the locking device 10 on the side door 2 is presented in FIG. 4. Here the locking device is fastened by a gluing seam 34 in a hollow space 23 of the door frame 8. The locking device 10 is here glued on a diaphragm 32 which covers the door frame 8 toward the outside. Otherwise the same mode of function exists for the locking device 10 in FIG. 4 which is already described in relation to FIG. 2.

The arrangement of the locking device 10 in FIGS. 3 and 4 have as a common feature that they are arranged along a vertically running door frame component 22 and stand in engagement with the roof frame 12 in their mode of action. Basically the locking device can also be arranged largely horizontally in an upper roof frame component and stand in engagement with a door column, for example the B column 14′.

Basically all suitable activation devices can be used for activation of the locking device 10. For the sake of clarity, the representation of such an activation device has been dispensed with in FIGS. 2 to 4. Electromagnetic and electropneumatic drives have proven themselves advantageous. In this connection, an electromagnetic drive has the advantage that the building up of compressed air can be dispensed with.

An electromagnet can be arranged in the roof frame, in the door body or in the door window space, for example, for realization of the drive device. By overcoming a likewise not represented spring mechanism, the locking pin 18 is drawn into the receiving opening 24 of the roof frame 12 in a closed state of the side pane 6. As long as voltage is applied to the electromagnet, the locking pin 18 is maintained in the locking position. When a door closing facility is activated, the locking pin 18 is released and pushed back into position 36. Pressing the locking pin 18 back takes place very rapidly through the already mentioned spring element owing to which the user does not notice the additional locking upon opening the motor vehicle door.

The locking facility is controlled such that when an accident occurs, the voltage is withdrawn from the activation device (for example), the electromagnet, and the latter releases the locking device to secure the occupants in the event of an accident. The locking device 18 is retracted into position 37 through the spring force. Consequently the locking is annulled and the door can be freely opened. In this connection, it is appropriate that crash sensors, which are present in the motor vehicle and are provided for the control of air bags, likewise assume control of the emergency unlocking of the locking device 10. Consequently, it can be guaranteed that the unlocking takes place with certainty in case of a crash. It is thus guaranteed in another emergency situation, for example in the event of a failure of the vehicle network or in the event of a power failure, that an unlocking of the locking device 10 takes place.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

I claim:

1. A side door of a motor vehicle, comprising:
a side pane that is enclosed by a door frame, and
a locking device which is arranged in a region of at least one of the side pane and the door frame and with which the side door can be locked in relation to a roof frame or a motor vehicle column above a flange edge.

2. The side door according to claim 1, wherein the locking device includes a locking pin which is arranged movably along a guide.

3. The side door according to claim 2, wherein the locking device is basically arranged on a door frame component running parallel to a median column.

4. The side door according to claim 2, wherein the locking pin stands in engagement with a receiving opening in the roof frame or in the motor vehicle column.

5. The side door according to claim 1, wherein the locking device is arranged in a hollow space of the door frame.

6. The side door according to claim 2, wherein the locking device is arranged on the side pane and engages into the roof frame or the motor vehicle column through a passage opening.

7. The side door according to claim 1, wherein the locking device is glued on its place of destination.

8. The side door according to claim 2, wherein the guide is in the form of a light metal section or in the form of a plastic section.

9. The side door according to claim 2, wherein the locking pin is configured of steel, plastic or a fiber-reinforced plastic.

10. The side door according to claim 3, wherein the locking pin stands in engagement with a receiving opening in the roof frame or in the motor vehicle column.

11. The side door according to claim 2, wherein the locking device is arranged in a hollow space of the door frame.

12. The side door according to claim 3, wherein the locking device is arranged in a hollow space of the door frame.

13. The side door according to claim 4, wherein the locking device is arranged in a hollow space of the door frame.

14. The side door according to claim 3, wherein the locking device is arranged on the side pane and engages into the roof frame or the motor vehicle column through a passage opening.

15. The side door according to claim 4, wherein the locking device is arranged on the side pane and engages into the roof frame or the motor vehicle column through a passage opening.

16. The side door according to claim 2, wherein the locking device is glued on its place of destination.

17. The side door according to claim 3, wherein the guide is in the form of a light metal section or in the form of a plastic section.

18. The side door according to claim 3, wherein the locking pin is configured of steel, plastic or a fiber-reinforced plastic.

19. The side door according to claim 3, wherein the locking device is glued on its place of destination.

20. The side door according to claim 4, wherein the guide is in the form of a light metal section or in the form of a plastic section.
